(19) United States
(12) Patent Application Publication
(10) Pub. No.: US 2020/0128818 A1
(43) Pub. Date: Apr. 30, 2020

(54) Rodenticide Without Secondary Poisoning Risk to Non--Target (Non-Rodent) Species

(71) Applicants: Zebariah Paul Gnehm-Fierro, Watsonville, CA (US); Peggy Ann Gnehm, Watsonville, CA (US)

(72) Inventors: Zebariah Paul Gnehm-Fierro, Watsonville, CA (US); Peggy Ann Gnehm, Watsonville, CA (US)

(21) Appl. No.: 16/169,109

(22) Filed: Oct. 24, 2018

(51) Int. Cl. A01N 25/00; A01N 25/34; A01N 25/32; A01N 65/44; A01N 65/12

(52) U.S. Cl. CPC A01N 25/004; A01N 25/34; A01N 59/08; A01N 65/44; A01N 65/12; A01N 25/32

(57) ABSTRACT

A no-secondary risk rodenticide has ingredients of a gastro-intestinal blocking agent as a dry ingredient, one or more plant matter attractant elements as dry ingredients, and sodium chloride. The blocking agent, the plant matter attractant elements and the sodium chloride are thoroughly mixed together, before being presented in bulk to target rodents.

### BACKGROUND OF THE INVENTION

### 1. Field of the Invention

The present invention is in the technical area of poison bait for killing rodent pests and pertains more particularly to a combination that avoids secondary poisoning.

### 2. Description of Related Art

It is well-known that rodents, such as rats and mice, are a very big problem in residences, and particularly in agricultural settings. Many commercial formulations are available, but to the inventors notice there are many continuing problems. One such problem is that rodenticides, such as those that use a blood-thinner chemical or other poisons pose a significant risk to pets, fowl, and other animals that may devour the poison directly or partly devour the carcass of a rodent that has ingested such a rodenticide.

Another problem is that, especially in use in a residence, rodents that are poisoned and die often succumb within the walls or under the floors of the residence, and the foul smell can be a very big problem. It is often difficult or impossible to find the carcass of a poisoned rodent and remove it from the premise. Said deceased rodents also attract flies and other vermin.

Therefore, what is really needed is a formulation of a rodenticide, and a method of administering same, that leaves a carcass of a dead rodent that is desiccated, and therefore poses no after-odor problems, and is not poisonous to any other animal that may consume the poison itself or at least a portion of the carcass.

### BRIEF SUMMARY OF THE INVENTION

In one embodiment of the invention a rodenticide is provided, comprising a gastro-intestinal blocking agent as a dry ingredient, one or more plant matter attractant elements as dry ingredients, and sodium chloride. The blocking agent, the plant matter attractant elements and the sodium chloride are thoroughly mixed together, before being presented in bulk to target rodents.

In one embodiment the gastro-intestinal blocking agent is corn gluten meal (CGM). Also, in one embodiment the one or more attractant elements comprise sunflower seeds and/or peanuts. Also, in one embodiment the sunflower seeds and peanuts are acquired fresh from wholesale outlets in sealed containers. And in one embodiment the sunflower seeds and peanuts are chopped before adding to the developing mixture.

In one embodiment of the invention the ingredients are measured and added by weight percentage of total, as corn gluten meal at 21-95%, peanuts and/or sunflower seeds at 5 to 79%, and sodium chloride at 0.01% to 5%. Also, in one embodiment water, a water-bearing vegetable ingredient, or oil, or a mixture, is added at up to 20%, to enhance the consistency of the mixture to be pelletized or formed into bars. The mixture may also be administered in a coarse flour like texture. In one embodiment the ingredients by weight are CGM at 85-86%, peanuts and/or sunflower seeds at 14-15%, and sodium chloride at 0.05%. In one embodiment the rodenticide further comprises one or more of, or a mixture, of oil, water, or a moisture-bearing plant material in sufficient quantity to enhance consistency of the mixture to be pelletized or formed into bars. The mixture may also be administered in a coarse flour like texture. In one embodiment the peanuts and sunflower seeds, if present, are acquired prior to preparation of the mixture, from wholesale sources within 5 days of harvesting. In one embodiment the mixture is formed into either pellets or bars. And in one embodiment the rodenticide is packaged into a hermetically-sealed container.

In another aspect of the invention a method for preparing a rodenticide is provided, comprising adding a measured quantity of a gastro-intestinal blocking agent to a developing mixture as one ingredient, adding a measured quantity of one or more attractant elements to the developing mixture as ingredients, adding a measured quantity of sodium chloride to the developing mixture as one ingredient, mixing the ingredients thoroughly, and packaging the ingredients in a hermetically-sealed container.

In one embodiment of the method the gastro-intestinal blocking agent is corn gluten meal (CGM). In one embodiment the one or more attractant elements comprise sunflower seeds and peanuts. In one embodiment the sunflower seeds and peanuts are acquired fresh from wholesale outlets in sealed containers. In one embodiment the sunflower seeds and peanuts are chopped before adding to the developing mixture. And in one embodiment the ingredients are measured and added by weight percentage of total, as corn gluten meal at 21-95%, peanuts and/or sunflower seeds at 5 to 79%, and sodium chloride at 0.01% to 5%.

In one embodiment of the method water, a water-bearing vegetable ingredient, or oil, or a mixture is added at up to 20%, to enhance the consistency of the mixture to be pelletized or formed into bars. Also, in one embodiment the ingredients by weight are CGM at 85-86%, peanuts and/or sunflower seeds at 14-15%, and sodium chloride at 0.05%. In one embodiment the rodenticide further comprises one or more of, or a mixture, of oil, water, or a moisture-bearing plant material in sufficient quantity to enhance consistency of the mixture to be pelletized or formed into bars. In one embodiment the peanuts and sunflower seeds, if present, are acquired prior to preparation of the mixture, from wholesale sources. In one embodiment the mixture is formed into either pellets or bars. And in one embodiment the rodenticide is packaged into a hermetically-sealed container.

### BRIEF DESCRIPTION OF THE SEVERAL VIEWS OF THE DRAWINGS

FIG. 1 is a flow diagram illustrating steps in providing a rodenticide according to an embodiment of the invention.

### DETAILED DESCRIPTION OF THE INVENTION

The present inventors are aware that certain products are available for use as rodenticides that claim to kill rodents by dehydration due to coating the intestines of the rodents to a substantial extent with materials such as corn gluten meal. The inventors have thoroughly tested most such products, and, although it seems that the materials, such as corn gluten, that may be effective in blocking water uptake and food digestion, can cause the blocking coating, that the products are not effective because the rodents do not eat a sufficient quantity to cause disability and ultimate death. It is simply true that for the product to be effective the rodents must consume it readily and in sufficient quantity that most of the rodents dehydrate and/or starve and die.

The present inventors have invested a great deal of time, money and effort in experimental production and application of formulations of ingredients that entice rats and mice, and in some cases other rodents, to enthusiastically ingest a sufficient quantity of a formulation of ingredients, including ingredients that cause intestinal blockage of the sort described above, to kill a substantial majority of a population of rodents in a geographic area, such as a farmstead or a residence.

In this experimental endeavor the inventors have found ample evidence that rats and mice, for example, are fussy eaters, not much attracted to the materials that can effectively cause blockage of the intestines. Also, true that, to be effective, the rats have to ingest a considerable quantity up front. If the intake is not sufficient, the rodents will survive the effects and revive. The conclusion of the inventors is that success of a formulation depends, at least in large part, upon enticing the rodents with different ingredients the inventors consider attractants, that are sufficiently effective to mask the odor and taste of the working ingredient or ingredients, and to also motivate the rodents to ingest sufficient quantity of the mixture to acquire enough of the blocking agent, in some embodiment corn gluten meal (CGM).

Another consistent observation is the importance of salt in the bait mixture. The inventors, in extended testing and experimental activity, have developed ample evidence that salt, added as common sodium chloride in some embodiments, as a part of the unique bait in embodiments of this invention is a very important ingredient. If the rodents, for example rats, have a large initial dose of the bait after an embodiment of the present invention, about 4-10 days later, rats become extremely thirsty. Rapidity of effect is based on quantity initially ingested. The rats come out of hiding and watch as bowls of water are filled, sometimes only inches away from a water bowl being filled by a person, and literally run to the water while the person is still present. Often 6-8 rats drinking together. Within 2-4 days bodies are found. Most rats seem to die in their nests, but there are other bodies scattered around the yard. They don't smell and tend not to attract flies. This is due to extreme dehydration at the time of death.

Experiment has shown as well that forms of salt other than common table salt are effective as an agent for increasing thirst and causing increased drinking of water.

The inventors know that the blocking agent, in many embodiments CGM, lines the intestines and severely depletes ability of the rats to digest food or to absorb (take water into) the blood stream from the intestines. The inventors believe that the rats become very thirsty partly because uptake of water is already depleted. But also, that that salt in the bait increases thirst, and causes the rats to require an increased water intake to maintain adequate electrolyte balance, causing them, subsequently causing them to ingest ever more water. And also, that the large quantities of water passing through the gastro-intestinal tract swells the blocking agent and enhances the effect of blocking digestion and further decreasing water absorption (and water uptake). A significant difference in the time required to achieve death has been noted with salt present and not present in testing recipes for the innovative bait in embodiments of the invention.

An example of an effective, very specific and unique formulation in an embodiment of the invention is:

### Example 1

85-86% corn gluten meal (CMG)

14-15% Roasted peanuts and/or sunflower seeds

0.05% salt

(Percentages are Dry Ingredients by Weight)

The peanuts and/or sunflower seeds may be chopped.

The CGM is preferably fresh, such as within no more than several days after manufacturing and packaging. This requirement is variable, but generally speaking, the fresher the better.

The formulation may be mixed CGM with the attractants thoroughly mixed in, or water may be added directly of in fruits or vegetable matter to provide moisture enabling the dry ingredients to be formed into balls, pellets or bars. The ingredient percentages above are dry ingredients by weight.

In this formulation the blocking agent is CMG and the attractant is either peanuts or sunflower seeds, or a mixture of both. Based on observation, the rats don't choke on the CGM. They are able to eat and drink after ingesting it.

Mice die after about 4 days. No bait shyness has appeared, likely because it takes several days for the formulation to take effect.

An important part of the process in embodiments of the invention is to use the freshest and most fragrant ingredients possible, and to preserve that freshness using air tight packaging. Both the CGM and the peanuts and sunflower seeds must be fresh and fragrant. Bait consumption is markedly decreased if the ingredients aren't fresh, and the kill rate markedly drops. In many embodiments of the instant invention the sunflower seeds and peanuts are acquired fresh from wholesale outlets, packaged and stored in sealed, airtight containers.

The exemplary recipe described above is very specific regarding narrow percentage ranges. In alternative embodiments of the invention the percentages may vary considerably from example 1 above.

A second example varies ingredients considerably:

### Example 2

Corn gluten meal 21-95%

Roasted peanuts and/or sunflower seeds 5 to 79%

0.01% to 5% salt

Moisture derived from water, oil, fruit or vegetables up to 20% for processing (for pellets or bars)

The gross recipe is:

Corn gluten meal

Roasted peanuts and/or sunflower seeds

Salt

Moisture sufficient for processing. (only if making pellets or bars)

Moisture sources potentially include fruit, vegetables, water or oil

Recipes could include CGM as the main ingredient with any desired attractant They could also include CGM mixed equally with any grain as the major component. All ingredients to be as fresh as possible.

### Example 3

Corn gluten meal: 70-90%

Roasted peanuts and/or sunflower seeds 10-30%

Salt 0.05 to 2%

Water or other moistening agent sufficient for processing if making pellets or bars as planned.

The product works best and fastest if there is a large initial feeding. Working from the premise that the blocking agent blocks absorption of food and water in the gastrointestinal tract, this makes sense. The more the GI tract is blocked, coated with the blocking agent, limiting absorption of water and to a lesser degree food, the faster it works. As stated above, freshness and aroma are very important, and to preserve same packaging in embodiments of the invention is to be in air-tight containers. In some embodiment product packages are foil-lined on fabric, paper or plastic, such as Mylar™ Such packages in some embodiments are heat-sealed.

In some embodiments the product package has a mark or a line indicating where a user is to cut the package, to leave a lower portion containing the bait, which may be simply set on the floor or the ground. In some embodiments one or more bait trays may be provided with a product sale, and the bait itself is provided in a larger, hermetically-sealed container, like, for example, a bucket, with a quantity sufficient to fill at least several bait trays.

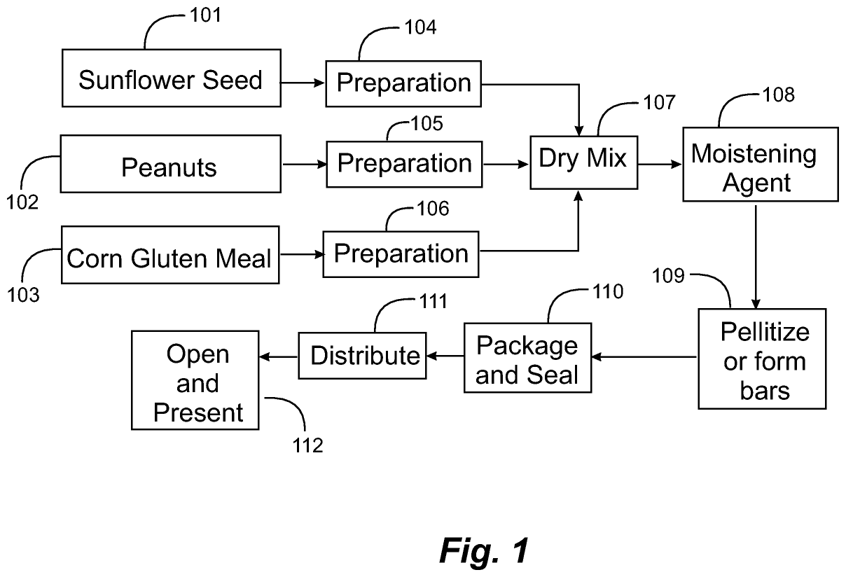

FIG. 1 is a flow diagram illustrating a process in one embodiment of the invention, for producing, packaging and using the no-secondary poisoning rodenticide. At step 101 a primary attractive agent is measured according to a recipe, typically expressed as percent by weight. In one embodiment the primary attractive agent may be fresh sunflower seed. At step 102 a secondary attractive agent is measured, in this example fresh roasted peanuts. At step 103 a quantity of corn gluten meal is measured according to the recipe.

Steps 104, 105 and 106 represent preparation steps for each dry ingredient, which may vary according to the ingredient. For example, step 104, where the primary attractive agent is sunflower seed, may dictate that the sunflower seed be chopped to a prescribed degree. Similarly, in step 105 the roasted peanuts (if used) may be crushed to a specific size. In step 106 the corn gluten meal may be prepared in a specific way. At step 107 the dry ingredients are mixed together.

In some embodiments the dry mix may be the final product, and steps 108 through 111 may be passed over. In other embodiments it may be desirable to provide the product as pellets or bars, for example, in which case, at step 108 a moisturizing agent may be required. In different embodiment vegetable matter or fruit may be measured according to a recipe and mixed with the dry ingredients. In other embodiments a volume of water may be added, and the result mixed, to make the material amenable to a mechanical apparatus to make pellets or bars at step 109 by a mechanical means.

At step 110 the pelletized material is packaged, as described above, in hermetically-sealed packages, which are distributed to points-of-sale in step 111. At step 112 the user opens one or more packages and presents the product in areas known to be frequented by the targeted rodents.

The skilled person will realize that the embodiments described are exemplary, and that there are likely many alterations that might be made within the scope of the invention. The invention is limited only by the scope of the claims below.

I claim:

1. A rodenticide, comprising:
a gastro-intestinal blocking agent as a dry ingredient;
one or more plant matter attractant elements as dry ingredients; and
sodium chloride;
wherein the blocking agent, the plant matter attractant elements and the sodium chloride are thoroughly mixed together, before being presented in bulk to target rodents.

2. The rodenticide of claim 1 wherein the gastro-intestinal blocking agent is corn gluten meal (CGM).

3. The rodenticide of claim 2 wherein the one or more attractant elements comprise sunflower seeds or peanuts.

4. The rodenticide of claim 3 wherein the sunflower seeds and peanuts are acquired fresh from wholesale outlets and packed in sealed containers.

5. The rodenticide of claim 4 wherein the sunflower seeds and peanuts are chopped before adding to the developing mixture.

6. The rodenticide of claim 1 wherein the ingredients are measured and added by weight percentage of total, as corn gluten meal at 21-95%, peanuts and/or sunflower seeds at 5 to 79%, and sodium chloride at 0.01% to 5%.

7. The rodenticide of claim 6 wherein water, a water-bearing vegetable ingredient, or oil, or a mixture is added at up to 20%, to enhance the consistency of the mixture to be pelletized or formed into bars.

8. The rodenticide of claim 6 wherein the ingredients by weight are CGM at 85-86%, peanuts and/or sunflower seeds at 14-15%, and sodium chloride at 0.05%.

9. The rodenticide of claim 8 further comprising one or more of, or a mixture, of oil, water, or a moisture-bearing plant material in sufficient quantity to enhance consistency of the mixture to be pelletized or formed into bars.

10. The rodenticide of claim 9 wherein the peanuts and sunflower seeds, if present, are acquired prior to preparation of the mixture, from wholesale sources in sealed containers.

11. The rodenticide of claim 10 wherein the mixture is formed into either pellets or bars.

12. The rodenticide of claim 11 packaged into a hermetically-sealed container.

13. A method for preparing a rodenticide, comprising:
adding a measured quantity of a gastro-intestinal blocking agent to a developing mixture as one ingredient;
adding a measured quantity of one or more attractant elements to the developing mixture as ingredients;
adding a measured quantity of sodium chloride to the developing mixture as one ingredient;
mixing the ingredients thoroughly; and
packaging the ingredients in a hermetically-sealed container.

14. The method of claim 13 wherein the gastro-intestinal blocking agent is corn gluten meal (CGM).

15. The method of claim 14 wherein the one or more attractant elements comprise sunflower seeds and roasted peanuts.

16. The method of claim 15 wherein the sunflower seeds and peanuts are acquired fresh from wholesale outlets in sealed containers.

17. The method of claim 16 wherein the sunflower seeds and peanuts are chopped before adding to the developing mixture.

18. The method of claim 13 wherein the ingredients are measured and added by weight percentage of total, as corn gluten meal at 21-95%, peanuts and/or sunflower seeds at 5 to 79%, and sodium chloride at 0.01% to 5%.

19. The method of claim 18 wherein water, a water-bearing vegetable ingredient, or oil, or a mixture is added at up to 20%, to enhance the consistency of the mixture to be pelletized or formed into bars.

20. The method of claim 13 wherein the ingredients by weight are CGM at 85-86%, peanuts and/or sunflower seeds at 14-15%, and sodium chloride at 0.05%.

21. The method of claim 20 further comprising one or more of, or a mixture, of oil, water, or a moisture-bearing plant material in sufficient quantity to enhance consistency of the mixture to be pelletized or formed into bars.

22. The method of claim 21 wherein the peanuts and sunflower seeds, if present, are acquired prior to preparation of the mixture, from wholesale sources in sealed containers.

23. The method of claim 22 wherein the mixture is formed into either pellets or bars.

24. The method of claim 23 packaged into a hermetically-sealed container.
